(19) United States
(12) Patent Application Publication
(10) Pub. No.: US 2016/0071059 A1
(43) Pub. Date: Mar. 10, 2016

(54) INFRASTRUCTURE MANAGEMENT, MODEL, AND DELIVERABLE CREATION SYSTEM AND METHOD OF USE

(71) Applicant: Shafer, Kline & Warren, Inc., Lenexa, KS (US)

(72) Inventors: Ronald D. Petering, Overland Park, KS (US); Timothy M. Sosinski, Kansas City, KS (US); Kurt W. Loudon, Parkville, MO (US); Todd W. Hamilton, Lake Lotawana, MO (US); Thomas R. Collins, Lee's Summit, MO (US)

(21) Appl. No.: 14/848,049

(22) Filed: Sep. 8, 2015

Related U.S. Application Data
(60) Provisional application No. 62/046,736, filed on Sep. 5, 2014.

(51) Int. Cl. G06Q 10/10

(52) U.S. Cl. CPC G06Q 10/103

(57) ABSTRACT

A project management system for automatically consuming input data to be used for tracking project statuses and generating maps and other deliverables used for infrastructure and other construction projects. The project management system is primarily used for generating project deliverables from field survey data and crew reports in the field, which is then checked and corrected by technicians in the office, after which the management system automatically generates as-built maps and tables used as final deliverables.

### CROSS-REFERENCE TO RELATED APPLICATION

This application claims the benefit of U.S. Provisional Patent Application No. 62/046,736, filed Sep. 5, 2014, which is incorporated herein by reference.

### BACKGROUND OF THE INVENTION

1. Field of the Invention

The present invention relates generally to the management of data associated with right of ways and other data which may be associated with any infrastructure development, the project management associated therewith, and in particular to a computer-based software system and method for storing, managing, retrieving, and displaying said project data. Output from the software program can be presented in a plurality of digital-based formats including but not limited to database tables, CSV files, Excel spreadsheets, reports, Portable Document Format (PDF), and image formats. Project participants benefiting from such a system and method include, without limitation: project owners, design professionals, project managers, accounting personnel, auditors, surveyors, consultants, regulatory enforcement officials, contractors, subcontractors, suppliers, vendors, and others involved in project planning, design, construction, operation, and maintenance.

2. Description of the Related Art

Large engineering projects typically involve correspondingly large volumes of project data. Moreover, they are commonly staffed with relatively large project teams. Such project information must be stored, managed, retrieved, displayed, and otherwise made accessible to various participants in the project design and delivery process.

The information management system and method of the present invention described is in connection with right-of-way information management generally, and with pipeline construction specifically. Without limitation, the present invention is broadly applicable in such diverse fields as: petrochemical transportation (including oil and gas, natural gas liquid, natural gas, and chemical and specialty chemical pipelines, and a plurality of other infrastructures which transport energy resources); communications infrastructure; consulting; energy distribution; military applications; water transmission, highway construction and the design and construction of infrastructure for all types of clients and customers, public and private.

In the fast paced world of pipeline construction the accurate flow of information between client, surveyors, and engineering and construction personnel is needed. What is needed is a web-based, multifunctional system to coordinate information and data sets when working on multiple projects spread over much of the United States.

Heretofore there has not been available a system or method for project management with the advantages and features of the present invention

### SUMMARY OF THE INVENTION

RIMS is an acronym for Right of way Information Management System. RIMS is a web based system used to store, manage, and show various types of data related to pipeline construction projects. It combines geo-spatial data presented in an interactive map and tabular data presented in table grids as well as documents in Adobe PDF format or other useable file types. RIMS is intended for use by engineering management, project staff, client staff, and subcontractors.

In the practice of the present invention, a preferred embodiment includes the following features and functions:
Server-based storage, management, retrieval, and display of project data associated with right of ways and other data which may be associated with any infrastructure development
Web (cloud)-based management, retrieval, and display of project data associated with right of ways and other data which may be associated with any infrastructure development
Web based editing of certain project data
Initial market application: pipeline design, construction, and as-built projects
Applicable to other types of construction projects
Multifunctional
Coordinating information and data sets for a single project or for multiple projects
Controlled (security protected) access by consultant management, project staff, client staff, and subcontractors
Compatible with other project/data management systems (open database and “agnostic”)
Automated data validation
Automated report generation
Multi-phase functionality (e.g., supports data storage, management, retrieval, and display during Preliminary Design, Construction, and As-Built phases of a project.)
Includes standard and custom Graphic Information Systems (GIS) functions

### BRIEF DESCRIPTION OF THE DRAWINGS

The drawings constitute a part of this specification and include exemplary embodiments of the present invention illustrating various objects and features thereof.

FIG. 1 is a box diagram showing the relationship between various elements of a preferred embodiment of the present invention.

FIG. 2 is another box diagram showing the relationship between various elements of a preferred embodiment of the present invention.

FIG. 3 is yet another box diagram showing the relationship between various elements of a preferred embodiment of the present invention.

FIG. 4 is a diagrammatic representation of a graphical user interface (GUI) associated with a computer displaying elemens of the preferred embodiment thereof.

FIG. 5 is another diagrammatic representation of a GUI associated with a computer displaying elemens of the preferred embodiment thereof.

FIG. 6A is another diagrammatic representation of a GUI associated with a computer displaying elemens of the preferred embodiment thereof.

FIG. 6B is another diagrammatic representation of a GUI associated with a computer displaying elemens of the preferred embodiment thereof.

FIG. 7 is another diagrammatic representation of a GUI associated with a computer displaying elemens of the preferred embodiment thereof.

FIG. 8A is another diagrammatic representation of a GUI associated with a computer displaying elemens of the preferred embodiment thereof.

FIG. 8B is another diagrammatic representation of a GUI associated with a computer displaying elemens of the preferred embodiment thereof.

FIG. 9A is another diagrammatic representation of a GUI associated with a computer displaying elemens of the preferred embodiment thereof.

FIG. 9B is another diagrammatic representation of a GUI associated with a computer displaying elemens of the preferred embodiment thereof.

FIG. 9C is yet another diagrammatic representation of a GUI associated with a computer displaying elemens of the preferred embodiment thereof.

FIG. 10 is a flowchart diagramming the steps taken during at least a portion of practicing an embodiment of the present invention.

### DETAILED DESCRIPTION OF THE PREFERRED EMBODIMENTS

### I. Introduction, Environment, and Preferred Embodiment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Additional examples include computing devices such as a mobile smart device including a display device for viewing a typical web browser or user interface will be commonly referred to throughout the following description. The type of device, computer, display, or user interface may vary when practicing an embodiment of the present invention. A computing device could be represented by a desktop personal computer, a laptop computer, “smart” mobile phones, PDAs, tablets, or other handheld computing devices. Projects may refer to any particular construction, engineering, or other related projects which may use the present invention.

The following glossary of terms may include terminology included herein. When such terminology is used, the intended definitions are as follows:
AGM—Above Ground Marker used as a reference point set near pipeline for pig as it passes.
Alignment Sheet—Also known as a strip map; specialized map for use in corridor industries such as transportation, electrical transmission, telecommunications and pipelines; they typically include a plan view (map) of a portion of the pipeline, accompanied by plan drawings (schematics) in the same scale and in exact alignment with the map.
Anomaly—An imperfection or defect present in a pipe wall.
APDM—ArcGIS Pipeline Data Model—APDM is designed for storing information pertaining to features found in gathering and transmission pipelines, particularly gas and liquid systems. The APDM was expressly designed for implementation as an ESRI geodatabase (therefore GIS centric) for use with ESRI's ArcGIS and ArcSDE® products.
Back End—The Back End are the crews behind the welding crew.
Backfill—The dirt/sand material used to cover the pipe in the ditch.
Bead—A Bead is the end product of two pieces of metal being welded as a result of a weld pass.
Bell Hole—A Bell Hole is a widened and sloped section of the ditch where welders will work when doing a tie in.
Berm—A dyke of earth material formed to contain fluid, such as fuel, in case of a spill or leak, or to divert water on a slope in the prevention of erosion.
Blacktop—Tar sealed road.
Blow Down—Releasing air or water pressure through valves at a test head, after testing a section of pipe.
Bone Yard—Lay down area for equipment adjacent to the pipeline area, usually either at kick off or the end of the line.
Boom—Pipeline side boom tractor.
Boxing a Sag—Squaring off the R.O.W. at a creek/river crossing.
Buckles—A deformity in the pipe resulting in an inward protruding bend, often caused by ditch rock or bending mistakes.
Bug—The automatic welding machine that welds inside or outside the pipe on a track.
CAD Welding—Welding test lead wire on the pipe and casing.
Cap—The top pass of the weld.
Cathodic Protection—The practice of protecting against environmental corrosion (soil or moisture) of underground or submerged metallic structures through the use of a negative potential applied by an external source to the structure.
Chainage—The accumulated length of the pipeline from Kickoff marked in feet or miles.
Clamp—A circular clamp hinged in half to facilitate encircling the pipe. Control the ends of two pipe joints or sections during tie-in welding.
Coating—The paint, plastic or dope the bare steel of the pipe is covered with from the factory or that is applied on the “Coating” crew.
Cold Bend—A bend formed without applying heat to pipe, usually done on-site.
Cold-Wrapping—Applying tape coating types that do not require the application of heat.
Combination—A bend incorporating a side bend, a sag or over bend.
Coupons—Sections of cut pipe, used for practicing welding. Also used to test the strength of a weld.
Daylighting—Exposing a utility that was previously buried.
Ditch line—Centerline of ditch, marked by red stakes, stones or markers along the right of way.
Ditchside—The side of the right of way on the opposite side of the ditchline from the workside, where the spoil pile is placed.
Dogleg—An irregularity in a straight line—in a pipe section, lay of the right of way etc.
Downstream—The direction the product will flow when in the pipeline is in service.
DRG—Scanned image of a U.S. Geological Survey (USGS) standard series topographic map.
Egging—Pipe becoming out of round, during bending process. Also called ovality.
FERC—U.S. government agency that regulates hydroelectric dams and interstate commerce in oil, gas, and electricity.
Final Tie-Ins—The crew that welds together or ties in, after test, the tested sections to complete a continuous pipeline.
Foreign Line—A pipeline crossing the centerline of the new pipeline under construction.
Front End—The crews ahead of and including the welding crew.
Geodatabase or Spatial Database—A spatial database, or geodatabase is a database that is optimized to store and query data that represents objects such as points, lines and polygons that are defined in a geometric space using x,y coordinate pairs.
GFDM—GeoFields format for the design of pipeline databases, based on the PODS standard.
GIS—A Geographic Information System is a computerized system for capturing, maintaining, analyzing, integrating and displaying any data related to maps or locations.
Going-Out-Side or Going Away Side—The Going-Out-Side is the downstream side of a section or tie in.
GPS (Global Positioning System)—A system of satellites that communicates with equipment on earth to determine precise latitude and longitude.
GPS (Unit)—An earth based assembly of equipment that communicates with a constellation of satellites to determine the precise latitude and longitude of the equipment that is communicating with the satellite.
GPS Shot—A calculation and recording of a single latitude and longitude as determined by a GPS unit and the GPS system of satellites
Heavy Wall Pipe—A Heavy Wall Pipe is a mainline pipe with a thicker wall thickness than line pipe.
HCA—A High Consequence Area is an area legally defined by the OPS as being especially vulnerable to damage in the event of a pipeline leak or failure.
HDD—HDD is an acronym for Horizontal Directional Drilling.
HDS—High Definition Surveying—A term used for land based 3-d LiDAR scanning
Hot Bend—Bend created by heating pipe first, usually formed off-site.
Hydro-Testing—Portions of newly constructed pipeline are filled with pressurized water to test line integrity.
High-Low—Condition when the pipe and weld is slightly out of true.
Holiday—A Holiday is a hole or gap in the coating of the pipe.
Hot Pass—Second weld layer or the filler pass of the weld.
Hot-Wrapping—Hot Wrapping is applying tape type coatings requiring the application of heat.
Jeep (Holiday Detector)—Electrical device used to detect abnormalities/holidays in pipeline coating.
Joint—A joint is a length of pipe.
Kick Off—The work site located at the very beginning of a pipeline mainline or looping project at the beginning of the pipeline project.
Mile Post—A Mile Post is a post indicating the mile chainage from kickoff.
Lathe—A wooden stake, sharpened on one end, driven into the ground and used to mark centerline of ditch, chainage, or other purpose.
Line Pipe—The Line Pipe is the mainline pipeline pipe.
LNG—LNG is an acronym for Liquefied Natural Gas.
Loop—A Loop is a parallel section of pipeline.
Looping—Looping is work done on a section of pipeline that parallels an existing pipeline system.
Loose End—A Loose End is the free, open end of a longer section of pipe.
MAOP—MAOP is an acronym for Maximum Allowable Operating Pressure.
NHD—A comprehensive set of digital spatial data from the U.S. Geological Survey containing information about surface water features such as lakes, ponds, streams, rivers, springs and wells.
Nightcap—Caps made out of material, plastic, wood etc. to fit over and close off the end of the pipe to prevent entry of foreign material.
NPMS—The National Pipeline Mapping System is a full featured GIS database containing the locations and selected attributes of natural gas transmission lines, hazardous liquid trunk lines and LNG facilities operating in onshore and offshore territories of the United States. Created by a joint government industry effort between the U.S. Department of Transportation's Office of Pipeline Safety, other federal and state agencies and the pipeline industry.
NWI—The NWI is a department within the U.S. Fish & Wildlife Service that produces information on the characteristic, extent, and status of the National Wetlands and deepwater habitats.
OPS—The OPS is a division of the US Department of Transportation, with a mandate to oversee and enforce federal pipeline safety regulations.
OPUS—Online Positioning User Service: www.ngs.noaa.gov/opus.
Open Architecture—Open Architecture refers to databases and technologies connecting and exchanging data with other databases and technologies.
Overbend—Vertical cold bend of pipe to create a downward deflection of pipe. A bend in the pipe that is convex—low on the ends and high in the middle.
Ovality: See Egging.
P.I.—Change in the direction of the right of way centerline, usually identified by a stake/lathe with the chainage written on it.
Padding—Selected finer material placed in the ditch beneath, beside and on top of the pipe to prevent damage to the pipe or coating by rocks. Usually 8″ is required under the pipe and 12″ beside and on top of the pipe.
Pass—A Pass is a weld once around pipe.
PDOP—Positional Dilution of Precision—It is the measure of the geometrical strength of the GPS satellite configuration. If satellites (SV's) are all clustered together or in a straight line you may get a poor PDOP message. To get the most accurate shot of the field you want this value to be as low as possible. The default cut off in the typical controller is 6.0.
PHMSA—The Pipeline and Hazardous Materials Safety Administration is the federal agency charged with the safe and secure movement of hazardous materials by all modes of transportation. The agency also oversees the nation's pipeline infrastructure.
PI—Point of Deflection/horizontal bend/side bend/vertical bend.
Pig—A probe sent through the pipeline to clean or inspect and map interior condition of pipeline.
Pig Launcher/Receiver—A Pig Launcher or Receiver is an access point to place pig in pipeline.
P.O.D.S—PODS is an acronym for Pipeline Open Data Standard. PODS is designed for storing information pertaining to features found in gathering and transmission pipelines and distribution lines, particularly gas and liquid systems. PODS was expressly designed for implementation in any relational database management system (therefore a database centric design). It was designed independently of any particular GIS, however PODS does store coordinate information so that it may be used with a GIS.
Pulling Head—A Pulling Head is a heavy reinforced end cap for a pipe section with a towing eye, for sustained lateral pulling of that section, used on road bores and river/creek sections.
Pup—A usable piece of pipe cut from a complete pipe section. See Project Number definition below.
Project Number or Project # or Project ID—The “Project Number” is unique identifier assigned to the pipe when delivered to the site and includes valves and any other pipe features or fixtures to be used in the pipeline being constructed. The Project Number is used as an inventory tool to help Inspection keep track of all pipe materials used and as a reference number for survey crews recording in the field. Once the pipe is welded, the field crew is able to verify joint and heat information if any discrepancies arise. If there is a problem, and information cannot be read, Pipe Tally can be called and given the assigned Project Number which the Tally person can then look up the correct joint heat and length of a particular piece of pipe. Wall and Coating thickness can also be verified if there are any questions. The Project Number is also a reference number the Field and Master Data Technicians use in creating the Final Pipe Tally and As-Built Spreadsheets that are turned over to the client.
River Weights—Circular concrete weights attached to the pipe when pipe is laid under water or in wet swampy areas.
RMS—RMS is the measure of multipath, which is when multiple signals are received from the same satellite. Multipath is caused by obstructions such as tree canopy, buildings, and other structures.
Roach—A Roach is a berm (mound of earth) over the pipeline.
ROW—ROW is the Right of Way of a pipeline.
Rubber Boot Seal—The seal between the casing and pipe on either ends of a road/river bore.
Sag—Sag is a vertical under bend pipe to create an upward deflection of pipe. A bend in the pipe that is concave—high on the ends and low in the middle.
Set In (Tractor)—The Set In is a tractor on the front-end pipe gang crew that picks up each succeeding joint and sets it into the welding clamps.
Shoot a Bend—Shoot a Bend is a term used to calculate the degrees of a bend with surveying equipment.
Shot—See GPS Shot.
Sideband—A Sideband is a bend in the pipe that directs the pipe to one side or the other.
Spacers—Devices strapped/bolted to the pipe to prevent it being damaged by the metal casing when the pipe is inserted into the casing. Spacers are used on road or river bores.
Spiral Pipe—Pipe with a spiral factory welded seam.
Spread—A Spread is an organizing method that divides the pipeline into more manageable units during a pipeline construction project.
Spread Man—Construction Superintendent.
Station OR Station Number—A number that represents a location along the pipeline that is measured linearly from the beginning pipeline. For example station 12322 or (123+22) is a location that is one hundred twenty three thousand feet from the beginning of the line measured horizontally along the line.
Straw Boss—The Straw Boss is the crew foreman's lead worker.
Stringing—The crew that moves the pipe from the pipe yard to the right of way and positions the joints along the right of way parallel to but sufficient distance from the ditch line.
Test Head—A short section of pipe with a convex end cap and valves, welded to the end of a section. Used in the filling of pipe and controlling pressure during testing operations.
Test Lead—Capped portion temporarily placed in pipeline for hydro-testing.
Test Point—Test point is a location in a pipe section chosen to be used as a work site for testing operations, where the welders have left two loose ends.
Tract—A piece of real estate that is defined as a closed polygon around a property of contiguous ownership.
Upstream—Upstream is the direction from which the product will come from when in service.
Utility—A utility is any pipeline, buried or overhead power line, fiber optic cable, sewer, etc.
VPN—Virtual Private Network—A VPN is a network that leverages public telecommunication infrastructure, such as the Internet, to provide secure (private) access to the organization's network from remote offices. This is in contrast to using owned or leased telecommunication lines.
Workside—The work side is side of the right of way on which the equipment and vehicular traffic operate.

### II. Preferred Embodiment Project Management System 2

Referring to the figures in more detail, the reference numeral 2 generally refers to a project management system (also referred to as RIMS, which is an acronym for Right of way Information Management System) capable of handlings several aspects of a project automatically and coordinating events without the need for human interaction to generate an optimized plan. Specifically, this system would be used regarding the right of way of pipelines and other project-related networks and systems.

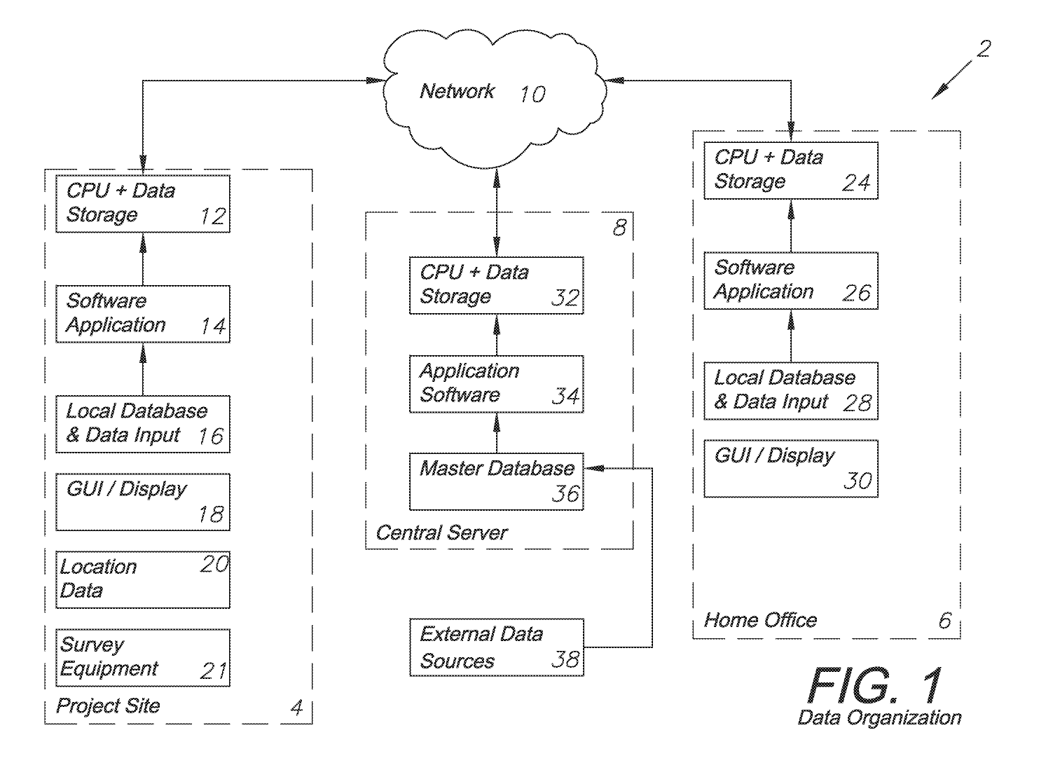

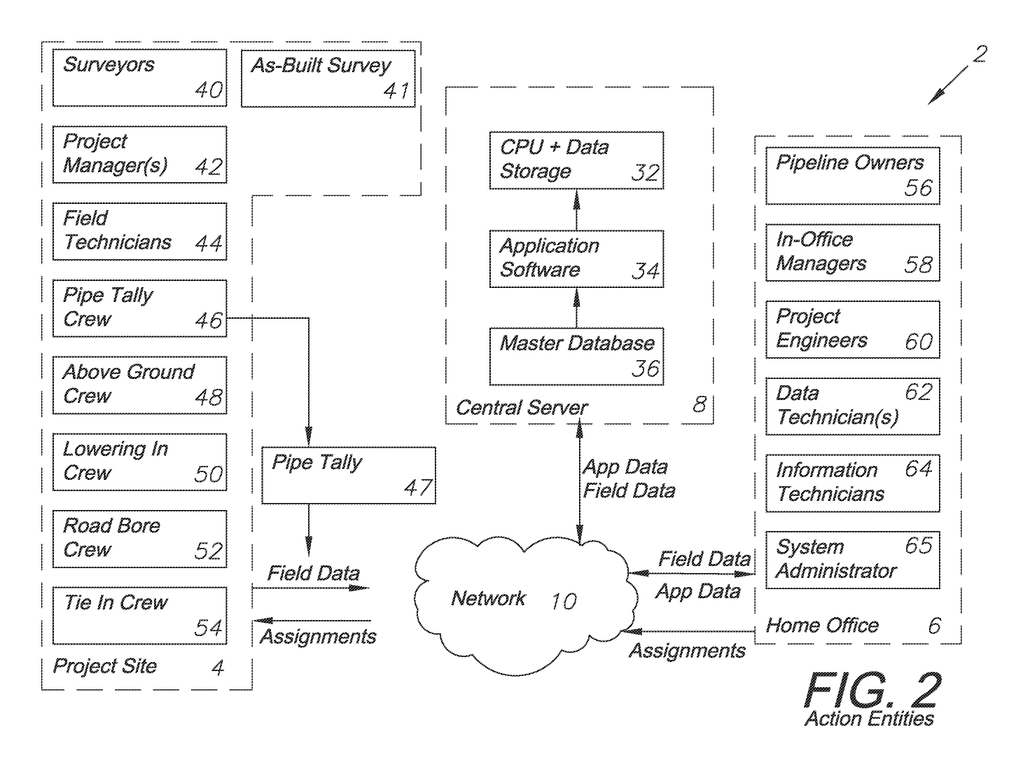

The management system 2 is generally broken into several phases. FIGS. 1-3 show generally some of relationships between various aspects of the management system 2 during these phases. Generally, the system is divided into a project site 4, a home office 6, and a central server 8 housing the software 34 associated with the management system. The project site includes several entities for gathering site data, such as site surveyors 40, project manager(s) 42, field technicians 44, a pipe tally crew 46, an above ground crew 48, a lowering in crew 50, a road bore crew 52, and a tie in crew. Other entities may also be associated with the project site. These entities gather real-time in-field data at various points during the project timeline.

The home office 6 is generally divided into additional entities, such as the pipeline owners 56 who may be the client requiring the construction project or are otherwise invested in the outcome of the project, in-office managers 58, project engineers 60, data technicians 62, information technicians 64, and other in-office staff.

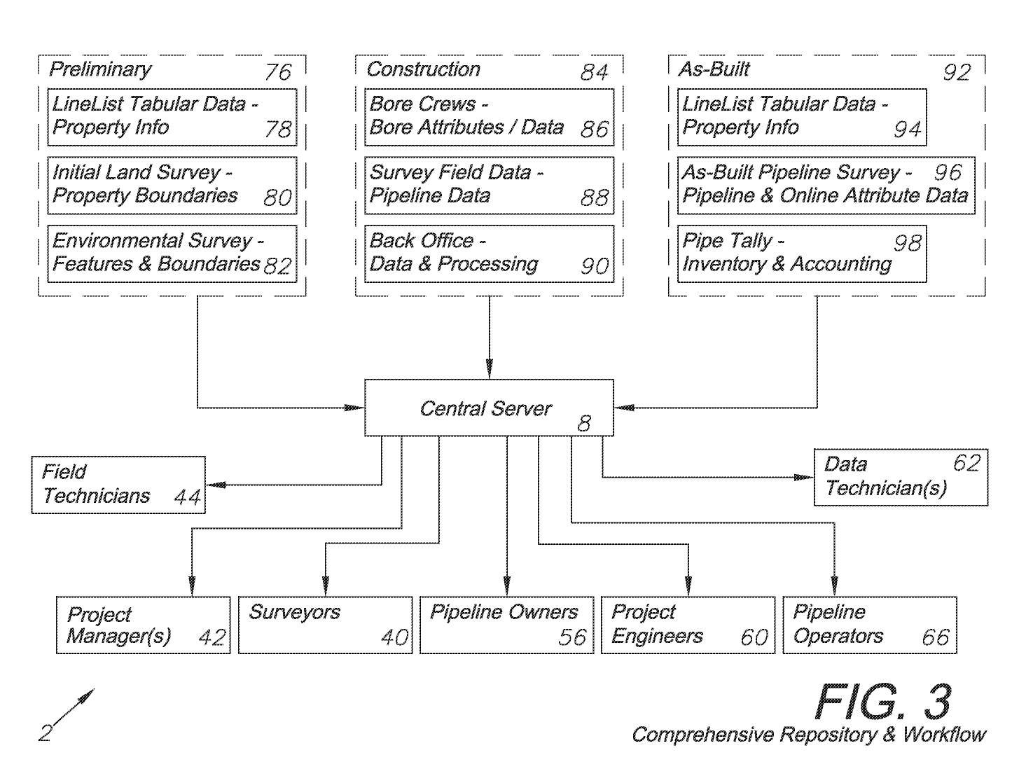

The first phase is the preliminary survey phase 76 which collects various points of data for the project site 4. As shown in FIG. 3, the data which may be collected includes: control points; section corners (if needed); property lines; crossings; preliminary pipeline center line; line list; property ownership boundaries; and environmental areas and archeological sites. Specifically, the preliminary survey phase 76 includes generating linelist tabular data (property info) 78, the initial land survey (e.g. property boundaries) 80, and an environmental survey including features and boundaries 82.

The second phase is the construction phase 84. Here, the process of placing stakes into the ground to identify the right-of-way, workspace, extra workspace for construction equipment, and trench location through the right-of-way. Points may be generated using drafting software such as AutoCAD software from Autodesk Inc. of Mill Valley, Calif., or similar software, and the points are loaded onto GPS survey devices 21. A surveyor 40 will physically stake the ground using the points on a tract-by-tract basis. Points to be indicated include at least: preliminary pipeline center line; right-of-way; work space; extra work space; trench; and PIs (e.g. bends or points of inflection).

The third phase of the management system 2 involves the construction phase 84 as built. Here, in the example of a pipeline, the pipeline segments are welded together then are actually placed into a trench. As-built shots are taken to reference and record the process at each weld, bend, fabrication, tie-ins, and bores. Documentation of various elements are uploaded to the management system 2, including: exact final pipe locations; exact final dimensions of pipes; exact final welds, sags, bends, and other factors; joint identifies; pipe coatings; weights; rock shields; and amounts of cover. Specifically, the construction phase 84 includes the bore crews 52 gathering bore attributes and data 86 (e.g. where bores are placed), the survey field data and related pipeline data 88, such as that which goes into the field books 73, and the office 6 data processing 90 generated from this data.

During the preliminary survey phase 76, the primary purposes are to: (1) identify properties to be crossed by a pipeline or other project; identify the owners of those properties and to create a line list (e.g. list of owners and contact information); acquire permissions to visit those properties; review the engineering and cost constraints associated with the proposed route; survey the proposed route; and identify the number of road and rail crossings to be traversed by the project.

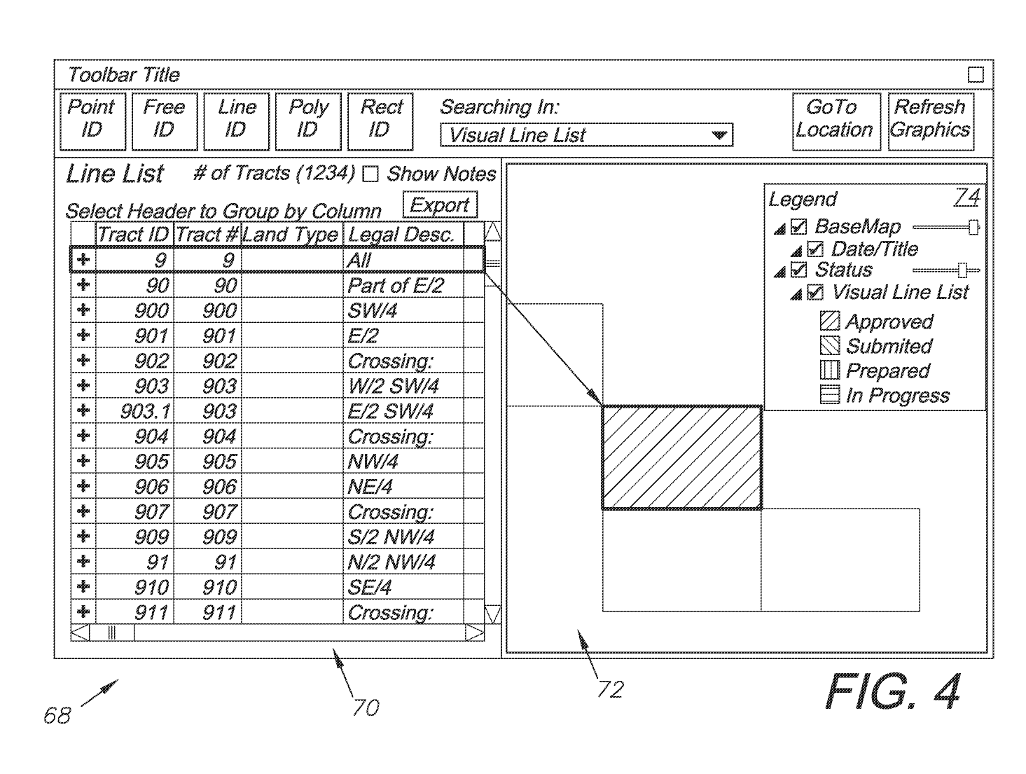

The management system 2 may be accessible through a standard web browser or other network access program. The management system 2 will track all changes, additions, and deletions to the line list 68 and is capable of displaying the line list in a tabular form 70 or map form 72 or alongside one another, as shown in FIG. 4. When viewing in tabular form, the system will display all property owners, tract ID's, and associated data. Sorting and filtering functions allow faster access to property or ownership lookups. Status fields may be edited to provide access permission, right-of-way acquisition, surveying, environmental assessment, and archeological assessment.

Similarly, the map view 72 provides the ability to search for a specific tract or owner, display all of the relevant tracts, display linear referencing and stationing, display the status of various tracking fields, and display aerial imagery (if any). The system may export mapped data in a variety of image formats for easy viewing and/or plotting. As shown in FIG. 4, when a selection is made on the tabular form 70 of the line list, that selection may be automatically shown in the map view 72 of the line list. A legend 74 can provide additional information which can be adjusted by the user.

The management system 2 is able to produce and export status reports for each preliminary survey step and phase. These can be used for final deliverables to clients, government entities, or for other purposes.

During a third, as-built phase 92, an accurate, in-ground, “as-built” record of the project (e.g. pipeline) construction is produced. The management system 2 will automatically produce the pipe record as data is input into the system. Field data collection involves documenting pipe dimensions, joint identifiers, pipe coatings, weights and rock shields, welds (with X-ray identification number), pipe bends, and the amount of cover over the installed pipe. Specifically, the as-built phase 92 includes the linelist tabular data (such as property info) 94 after the construction is complete, the as-built pipeline survey including pipeline and online attribute data 96 gathered by as-built survey crews, and the pipe tally (e.g. the pipe tally book 47) including inventory and accounting 98.

The as-built survey records actual horizontal and vertical dimensions of the pipeline using a GPS unit as measured within the control datum established during the preliminary phase 76 survey. The as-built 92 survey is performed after the pipe is lowered into the trench or ditch; however, much of the pipe inventory survey work is done before that and recorded into the management system 2. FIG. 1 shows how data is collected at the project site 4 using survey equipment 21 to collect location data 20 and other relevant data. This data is stored in field books 73, including such data as pipe tallies 47. The data is sorted in a local file 16 and is uploaded to the central server 8 using a project site computer 12 via a display or graphical user interface (GUI) 30 and a software application 14 linking the site to the management system software 2.

The as-built survey crew 41 which takes the GPS “shots” establishing the exact, final location of the pipe, welds, sags, etc. relies on the data collected beforehand by the pipe tally 47 and above ground crews 48. In addition, field notes 74 must be constantly coordinated among the three types of as-built survey crews: lowering in 50, road bore 52, and tie in 54. Finally, the information is transmitted to the home office 6 personnel via the management system 2, and the office personnel are tasked with updating base maps, databases and alignment sheets on a daily basis. FIG. 1 shows a simplified diagrammatic representation of how the data is fed through the central server 8 via a network and sent to the home office 6 where it is housed in central server 24 and accessed with management system software 26, which may include local data inputs 28 via a GUI 30.

The central server 8 houses the project management system 2 on a local computer 32 having its own application software 34 which powers the management system, and a master database 36 which houses all project data. External data sources 38 such as basemap data may also be pulled into the central server and used on projects as needed.

The survey crew 40 is active even before pipe is brought to the construction site, ensuring the contractor who clears and levels the pipeline route stays within the legally surveyed and staked workspaces. Next the contractor's stringing crew is instructed to lay out the pipe along the route in preparation for installation. The various field crews are then instructed to go to work.

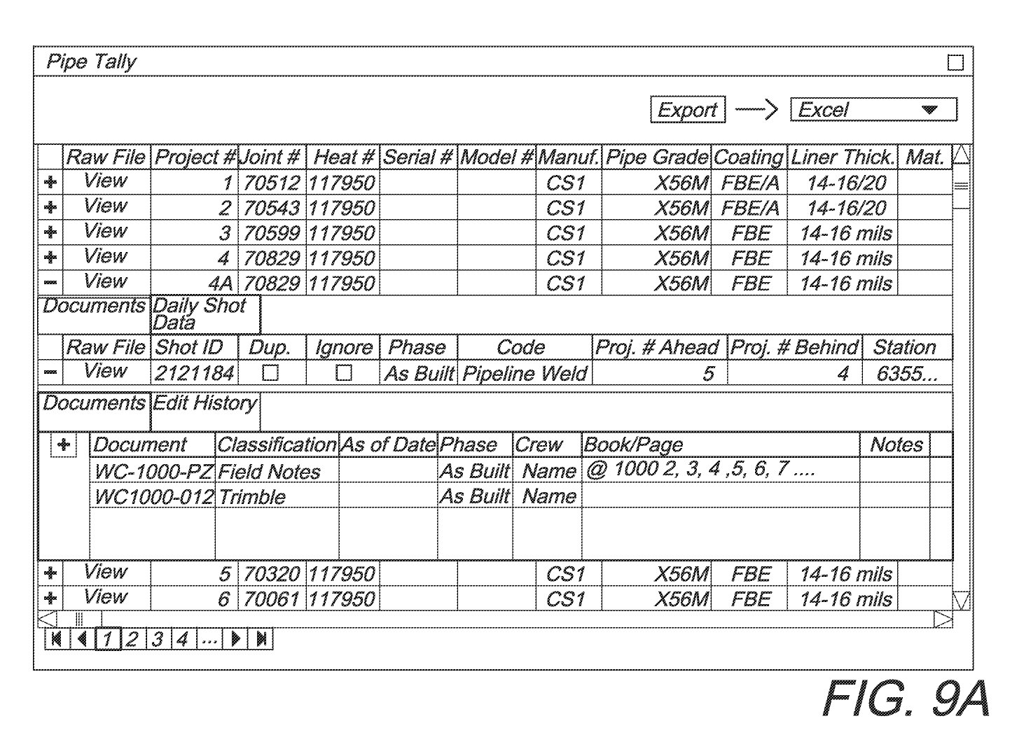

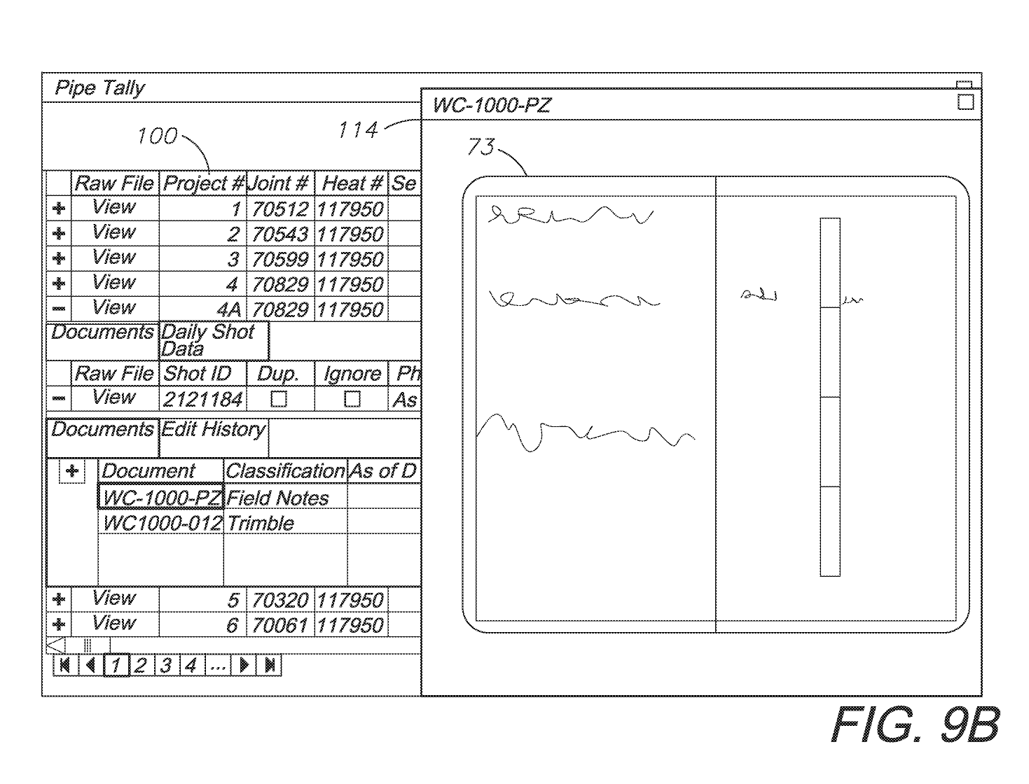

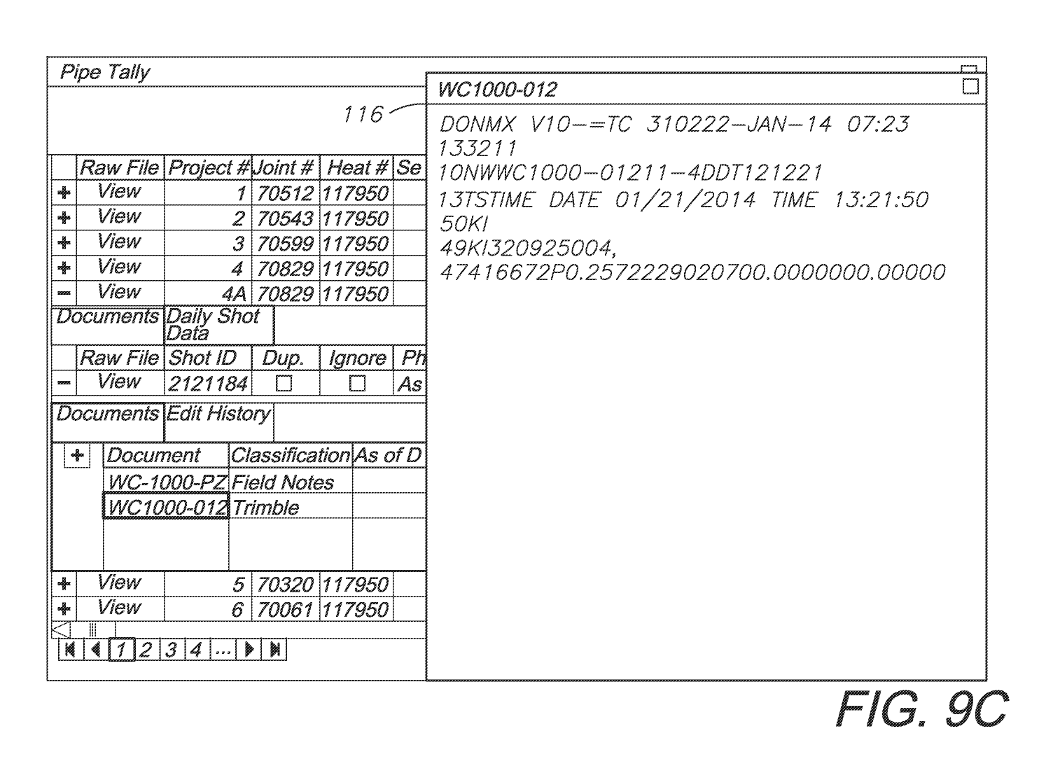

For each piece of pipe or other project element placed along the route, the tally crew 46 (e.g. pipe tally crew) records various pieces of information within a pipe tally 47 (usually in a pipe tally book). For pipe laying, the tally crew 46 records the joint number, the heat number, the length, the manufacturing process, the yield strength, and the type of coating. The joint is assigned a unique project identification number 100, which is used to track the pipe through the rest of the survey process. A field book is updated with the tally information and is added to the database 36 for the project management system 2. The field books may actually be scanned into the database and saved as field book files 114 as shown in FIGS. 9A-9C. The scanned image of the field book can be used to double check entered data in the database. Actual data from the GPS devices of the survey equipment 21 may be stored in a text file 116 and referenced or used in generated map information and other deliverables. Generally all information can be exported to other file types as explained below.

After the tally crew 46 records the pipe information, the contractor's welding crew (a.k.a. “firing line”) welds sections of pipe together into pieces of continuous pipeline called drag sections. These sections are longer for pipe which is installed on the main line in a continuous process where the crew can install two-to-three miles of pipeline a day. Drag sections that must pass through a bore made underneath of a road, creek, railroad, or other un-trenchable feature will generally be shorter sections cut to fit the purpose needed.

This team laying the pipe or otherwise working the project may be referred to as the “above ground team.” This team confirms the pipe information recorded by the tally crew 46 and further records the weld numbers, measures the bends, and marks the pipe sections for “shooting” by yet another team which may be referred to as a “lowering in crew” 50. The “lowering in crew” 50 will only need to fill in the blanks in the field book left by the above ground team, recording the shot numbers by the features, noting any additional features created during the installation process, and measuring the cover over the installed pipes. This data is fed back into the management system 2.

As pipe is lowered into the trench or ditch by the “lowering in crew” 50, GPS coordinates are collected at each weld and bend and uploaded to the management system 2 database 8. Survey shots of the ground are taken on the non-working side of the trench, 90 degrees from a weld or a bend. The difference of these two elevations is then used to calculate the depth of soil covering the pipe segment. GPS coordinates are collected on the pipe and either side of the pipeline for any land feature, utility crossing, or installed material. Shot numbers are recorded next to the field book notes for these features. Any features not already accounted for in the notes are recorded and stationed. The “lowering in crew” 50 are also responsible for double checking the field note information and entering it into the data recorder. The positioning, pipe, and feature information collected by the GPS equipment and the data recorder are the final basis for the as-built survey.

Another working crew referred to herein as the “road bore crew” 52 for pipe installations or similar jobs also records the same type of information as the “lowering in crew” 50, but for shorter drag sections of pipe which are cut and welded to fit the length of a bore made underneath a feature or obstacle, such as a road or a creek. The pipe typically has a thicker wall and heaver coating than mainland pipe in order to withstand being dragged under the road or feature through the bore. Pipe information has been recorded by the tally crew 46, however the road bore crew 52 must check the pipe information carefully to determine that the pipe sections are in the correct order before they are welded together or otherwise connected. The shot ids (weld numbers or other connection numbers) are then recorded and included in the database 8. Finally, the road bore crew 52 must ensure that the field book 74 data are cross-referenced to the mainline notes.

Gaps left between the main line and the road bore sections (or other sections, such as gaps left where land plots were not ready to have pipe installed on the landowner's property, for valve assembly, or for other reasons) must be filled in with tie-in sections. These may consist of one joint of pipe cut to fit the gap or of several welded together. The “tie in crew” 54 records the same type of information for that section of pipe as the lowering in 50 and road bore crews 52 do for theirs, respectively. In addition, the tie in crew 54 will usually have to account for “cuts” or “pups” cut off a pipe joint to make it the correct length to fill the gap. They must also coordinate with the other survey crews to ensure that all field books are correctly cross-referenced (e.g. if space has not been left in the main line field book to record the Tie In information).

Once the survey crews collect the relevant data, it is transferred back to the main office database where data technicians begin reviewing the data. The field data is used to produce constantly updated base maps, pipe tally spreadsheets, and alignment sheets. All survey data and field notes must be submitted to the main office database within 48 hours of when the data is collected. During these 48 hours, the field notes are scanned and all data is checked against the field notes for accuracy and completeness. This process may be assisted by the management system 2.

The pipe tally and as-built spreadsheets must be updated, with relevant pipe data, within 48 hours of the field survey submittals. Once construction on a hydro-test section is complete, the pipe tally and as-built data for those sections will be quality checked against the field notes and base map for accuracy and completeness. All final as-built deliverables must be compiled concurrently with construction progress and completed immediately after the final tie-in is made. By implementing the process described above, the project engineers can deliver final as-built alignment sheets within a brief period of project completion as generated by a separate alignment sheet generation software package.

The management system 2 (a.k.a. RIMS) is designed to import, store, merge, display, analyze and create reports of critical data for managing one or more pipeline construction projects. RIMS functions as an integration environment for: right of way property acquisition and surveying, owner contacts or line lists, document tracking, construction staking, As-Built surveying, pipe tally tracking and reporting, survey control, environmental tracking, and permit tracking At the current time the priority for completing components of the system generally are: 1) ROW Property acquisition and surveying integrated with line lists, 2) construction staking, and 3) As-Built surveying and tally sheet generation.

One of the primary functional requirements for the management system 2 is for the system to operate in an accessible, web-based environment to provide various users with access to the data from anywhere with internet access. The data becomes accessible after it is transferred, reviewed, uploaded, and processed by the management system 2 to the predetermined users.

Individuals are assigned a user role either as a Client or as part of the Project Team. The Client roles can be as the Client Project Manager (PM) or as Client Upper Management to view data and status reports. The project team roles can be project engineer staff or other subcontractors. Project engineer staff can include: Field Crew Chief, Back Office Survey Technician, SKW Project Manager (PM), SKW Upper Management, Engineering, GIS Technicians, Data Base Administrator (DBA). Subcontractors would include Sub-Contractor Survey Crew. The project team role is the people doing the work and collecting the data to be viewed from the internet.

In order to access the data, the Survey Crew Chief must first upload the data. Next the data technician 62 reviews the data prior to publishing it. Then the Server processes the survey data into feature classes

A data merge feature is automatically performed using the management system 2. Data merge occurs when the daily shot files are imported into RIMS. The system automatically merges the shot files with all other data for the pipe line project. RIMS updates all project tables in the system and converts data into GIS layers. During this process shots are linked together to form pipeline segments and then paired with the pipe joint tally information based upon the data collected by the GPS unit.

Once data is available via the management system 2, it may be viewed using many various computerized tools. That data in the management system 2 may be explored freely using various software tools. The following list is a non-exclusive list of some of the functions possible while exploring data in the management system 2:
Pan—allows movement around a map image relative to the display window without changing the viewing scale.
Zoom—displays a map image of either a smaller or larger area by zooming in or out of a specified area.
Identify—is used to select one feature to identify data, show feature location, view feature attributes and copy feature fields.
Search by Tract ID—enables the user to search for individual tract identification.
Zoom to Tract ID—displays a close up image of the area containing the Tract ID.
Zoom to Station—displays a close up image of the Station.
Searching In—is a query builder/SQL search statement of an expression to select features or records from a database.
Initial Extent—shows a view of a defined area of interest.
Set Active Layer—is used to select which layer from the Legend is identified.
Measure—is used to measure lines or areas.
Show Legend—is used to turn on or off the legend for the Initial Extent.
Print Map—allows the user to select an area of an Initial Extent to be printed to paper or to an image file.

All data is stored on a server 8 associated with the management system 2.

Data validation is automated by the management system 2. After the data technician 62 reviews data, the data is uploaded to the server where automated system validation occurs. The management system 2 server 8 checks for coordinate values within a minimum and maximum limit of the project. It checks to make sure IDs are in an assigned range. It also checks survey codes are valid and compares them to the project code list. Lastly, it checks GPS unit metadata against project settings.

Reports are made for each phase of the project. A report will track the status or the property survey, environmental and archeological survey, property acquisition and preliminary alignment. Construction staking status is processed tract by tract as they are staked. As-built status is tracked by joints laid in, number of welds, and the percent of total pipeline length laid.

### III. Project Management System 2 in Detail

The project management system 2 (RIMS) has many functional components which are useful for managing and tracking data; viewing the progress of a project using interactive geospatial components; and creating status reports and final deliverables. This section serves to introduce the main components of RIMS with more specific details given for each of the interfaces in later sections of this document.

A new project account is created using the project management system 2 connected to the network 10. Criteria are set by a project manager 42 and a systems administrator 65 to determine project settings and access credentials for different personnel to view or process data. Additional interfaces may be accessed through a project settings window 102 on the display of the computer when determining appropriate settings, such as references, shot codes, and manufacturers for parts.

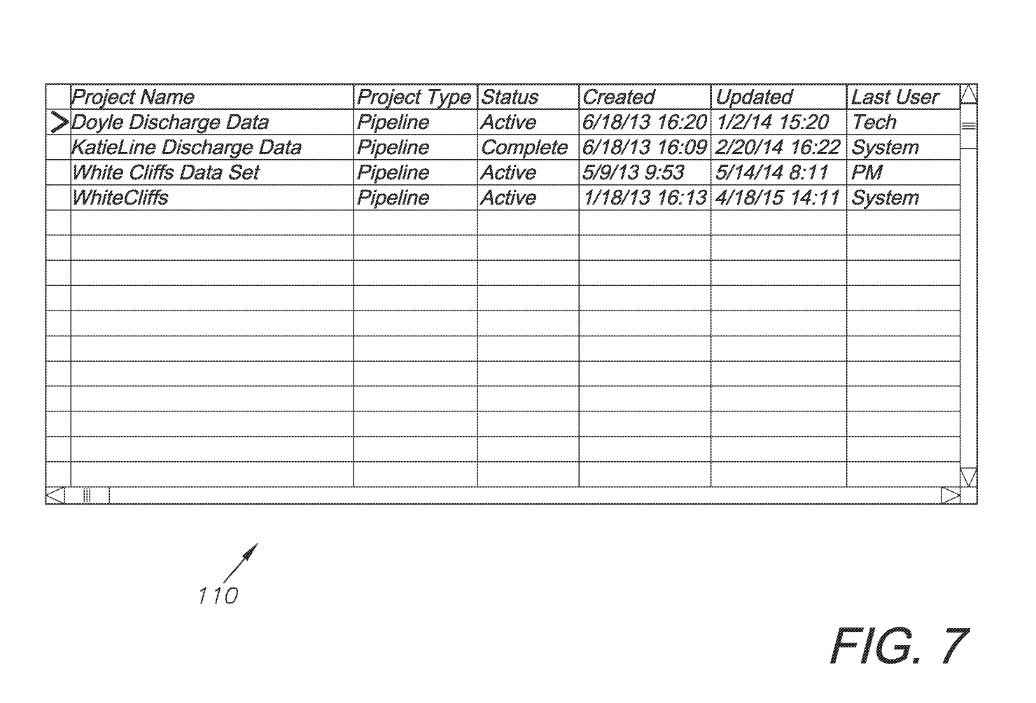

Previously created projects may similarly be opened via a project computer, such as the site computer 12 or the office computer 24, through a projects library list 110 stored on the database 8 of the server, as shown in FIG. 7. The projects are displayed in a list and allows any user with appropriate access to open a project or portions of a project. The list includes status information, such as whether the project is ongoing or finished and other general project data.

Accessing and editing project data of the project is a very dynamic component of the project management system 2. The project info component allows data for a project to be accessed, reviewed, and managed. It lists what data has been collected for a particular project and will show the status of that project. There are multiple interfaces associated with the project management system 2 which can be accessed through the project info page 120 for a specific project.

The project management system 2 in a preferred embodiment supports several data types. The first data type is vector data, which is used to store items such as survey points, pipeline segments, and tracts. Vector data for the present invention generally includes: (1) any point (or coordinate pair); (2) a line (or string of coordinate pairs); and (3) a polygon (e.g. a closed string of coordinate pairs). A GeoDataBase is stored in the project management system 2 as part of the central server 8, and may be incorporated into the master database 36 or separately stored. In a preferred embodiment, the GeoDataBase is built from survey data collected into feature classes, such as joints, welds, bores, and other location based facilities.

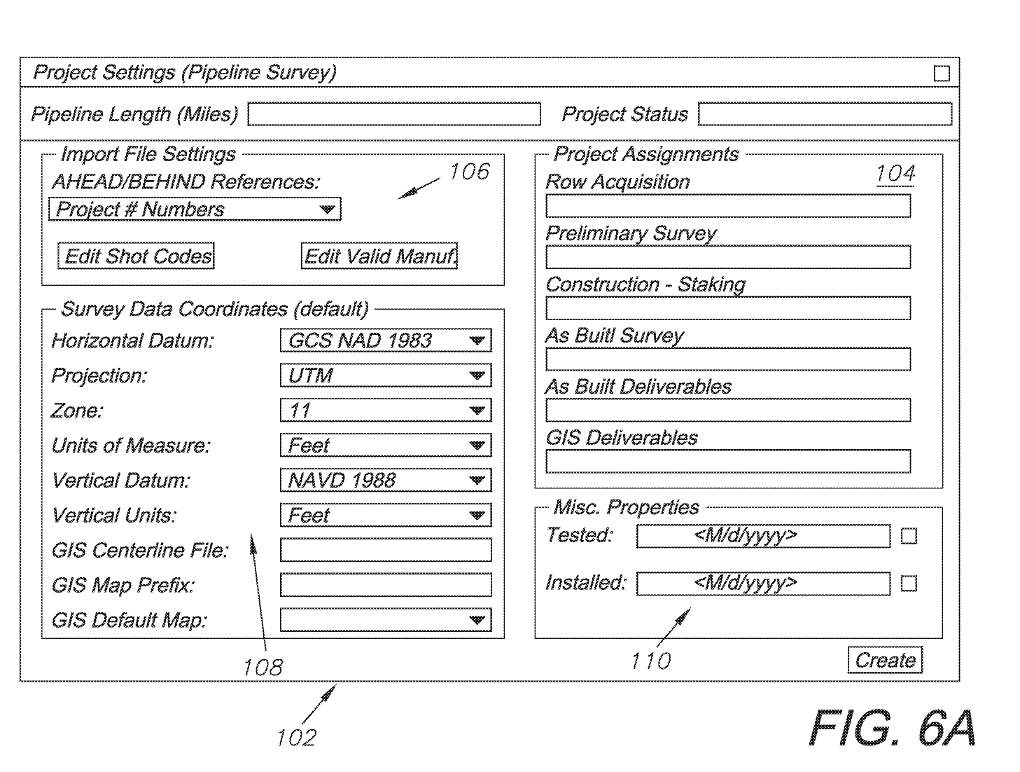

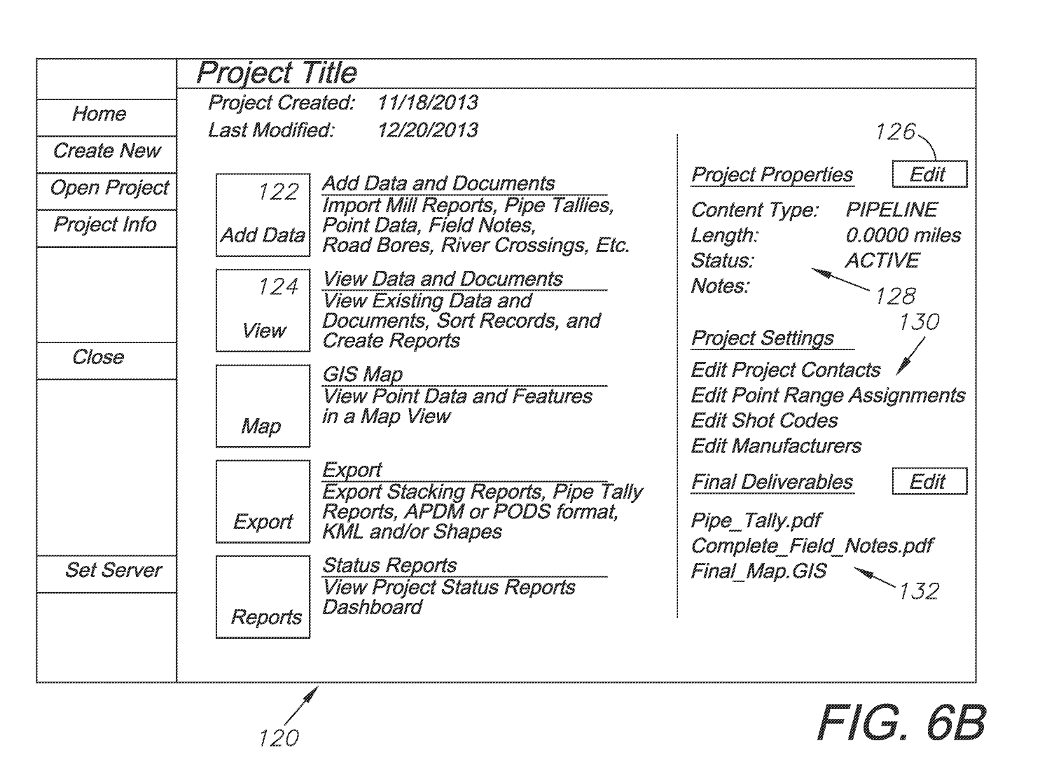

The second data type is raster data (a.k.a. image data), which is used in two different ways. Raster data is used as a reference layer in the Digital Maps view. Raster data is also used from photos taken at field cites of points and facilities. The field photos are then linked to features using an “add documents and data” 122 command in the project info interface 120 as shown in FIG. 6B and results in the features being included in the management system 2 as shown in FIG. 9A. The field note data then can be viewed in a table format or viewed in the digital maps view interface on top of the referenced layer. These views may be alternated back and forth as needed. Raster data is typically stored in .pdf format or photograph files uploaded into the “add documents and data” section of the project management system 2 software. Formats can be either in tables or graphics. Typical file formats include: CSV, PDF, JPEG, and TIFF formats. Other formats (existing or created in the future) may also be used.

The project management system 2 essentially uses software broken up into various interfaces which may be accessed by various members of a project team. In a preferred embodiment, the project management system 2 can be accessed using any standard web browser software. Alternatively, proprietary software could be used; however, using existing web browser software provides increased accessibility to the system. As discussed above, access to the system is restricted to users on a project-by-project basis. Control of access is determined by the project manager 42. After logging into the system, a user is provided with three primary interfaces to choose from as shown in FIG. 6B.

The “open projects” window (not shown) is the first to appear after a user logs in. This is the starting point for many of the interfaces available in the project management system 2. The primary interfaces accessible through the open project interface include: (1) creating a new project; (2) the projects library 110; and (3) the project info interface 120.

The projects library interface 110, as briefly discussed above and shown in FIG. 7, provides an interface where current or completed projects are viewable. The project library opens the door to each project's information through the unique project info interface 120 for each project. Several filters allow projects to quickly be found or searched through. These filters include: project name; project type; project status; creation date; last update; and last user updated.

When a new project is created using the new project function, several pieces of information must be provided for the new project. This information includes at least a project name, a project number, and a project type. Other relevant information, such as the location and the project manager 42 may also be entered at this time, along with other project settings.

The project info interface 120 as shown in FIG. 7 is the beginning access point for data and document management. This is where data is imported, processed, uploaded, tracked, and exported for individual projects. Elements of Project Info will be discussed in greater detail in later sections. Below is a brief summary of data and documents Project Info manages:
Add Data and Documents-Import Mill Reports, Pipe Tallies, Point Data, Field Notes, Road Bores, River Crossings, etc.
View Data and Documents-View Existing Data and Documents, Sort Records and Create Reports
GIS Map/Line List View-View Point Data and Features in Map View
Export-Export Status tracking Reports, Pipe Tally Reports, APDM, or PODS format, KML, and/or Shapes
Status Reports-View Project Status Reports Dashboard
Edit Project Properties-Content Type, Length, Status, Notes
Edit Project Settings-Project Contacts, Point Range Assignments, Shot Codes
Edit Final Deliverables-As-Built Alignment Sheet, Complete Combined Field Notes

The project manager 42 can set up extensive project settings to control who has access to various pieces of pipeline project data. In a project settings window 102, the project manager 42 can set elements such as: pipeline length; file settings (may be imported); survey data coordinates; project status updates; project assignments; and other miscellaneous properties.

When importing file settings, three additional interface extensions are available to the user. The project manager 42 can import references from the engineering company in charge of the project that may have been used for previous projects. The project manager 42 may also edit shot codes, or validate manufacturers from a project settings window 102. A few examples of what may be imported and edited include:
Import Unique ID Reference Numbers
Import Joint Numbers
Import Barcode Numbers
Add New Shot Codes with Description
Delete Shot Codes
Add Client Shot Code Translations
Enter Shot Code Acronym
Add New Manufacturers with Description
Delete Manufacturer

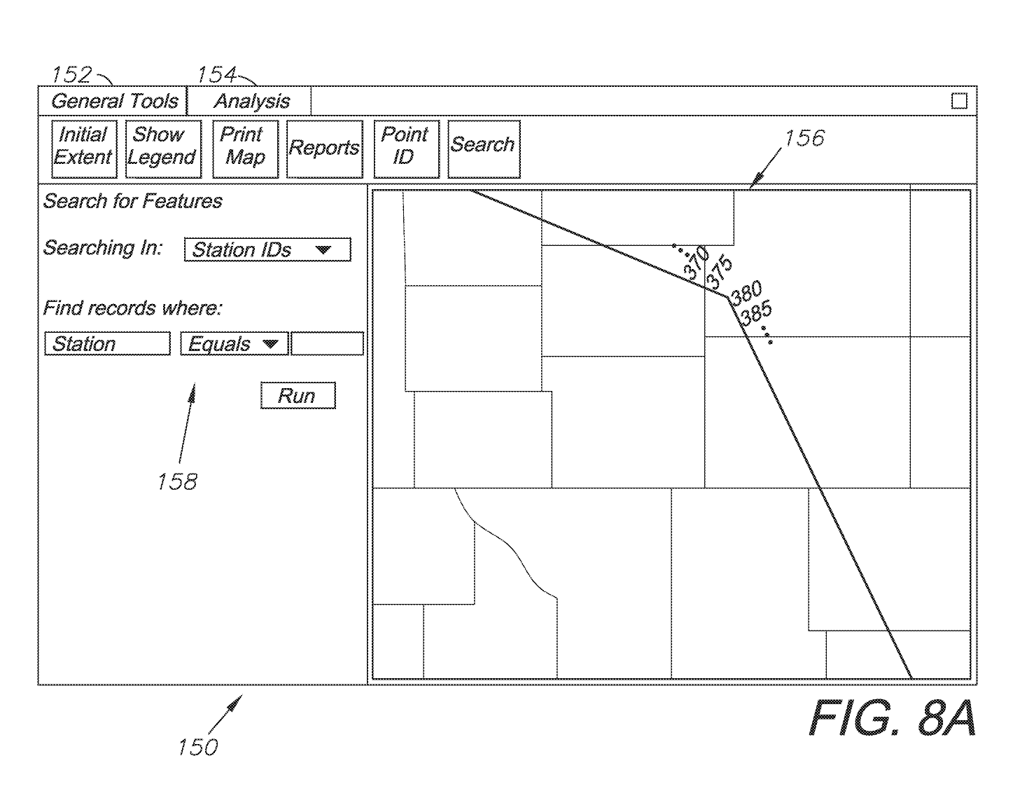

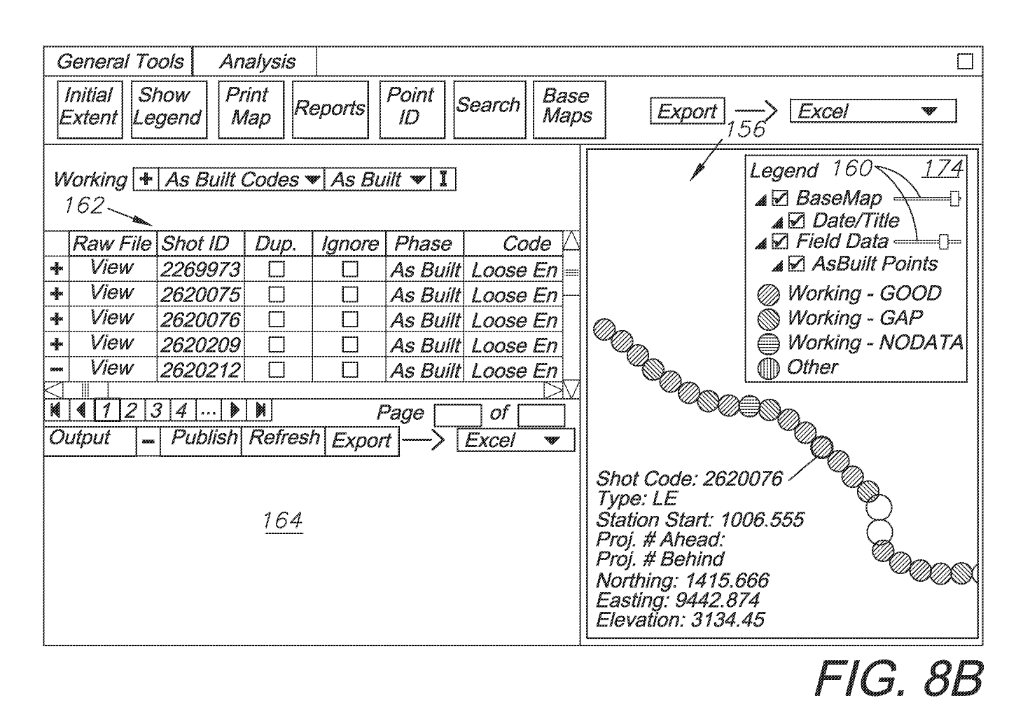

The Digital Maps viewer 150 is a map view interface as shown figuratively in FIG. 8A. Progress on a project or data from a finished project can be viewed graphically. The digital maps interface window can be broken down into the main menu component, the table of contents component 158, and the map view component 156. An export function allows both tabular and graphical data to be exported, including as-built features, pipe tallies, line lists, and graphic data in a variety of graphic formats. Similarly, status reports may be created and viewed using this or other data.

As discussed above, the project manager 42 will initially setup a project using the management system 2. During the initial setup, the project manager 42 can use the project settings interface 102 to control who has access to pipeline project data for viewing and/or editing purposes. As shown in FIG. 6A, one window of the project settings interface 102 allows the project manager 42 to set: pipeline length; import file settings; enter survey data coordinates; update project status; select project assignments; or alter other miscellaneous properties.

The import file settings interface 106 includes three interface extensions of the project settings interface 102. As shown in FIG. 6A, the project manager 42 can import references used in other projects, edit shot codes or valid manufacturers from the project settings window. Some of these pieces of information which can be imported and edited for each project include: engineering company reference numbers; joint numbers; barcode numbers; delete shot codes; add client shot code translations; enter shot code acronyms; add new manufacturers with description; and delete manufacturer.

The survey data coordinates interface 108 allows the system administrator 42 to enter what coordinate system and related data is to be required on the project. Some of the data will employ a default setting that may be modified or changed by the systems administrator 65, if needed. Default settings are for data maintained in commonly used projections within the United States. The data entered into this section include: horizontal datum (default); projection; zone; units of measure; vertical datum (default); vertical units; centerline route name; digital map prefix; and GIS default map.

The project assignments interface 104 is a dialogue box within the project settings window 102 and allows the project manager 42 to manually input assignments to contractors or other participants in the project. These participants are responsible for specific data collection, as indicated by the fields. An example is shown in FIG. 6A as part of the project settings interface.

The last portion of the project settings interface 102 is the miscellaneous properties form. This form is for tracking when the project management system 2 is downloaded onto remote devices for use by crews in the field.

Once the basic settings have been determined by the project manager 42 there are more project settings to be accessed through the project info interface 120 as shown in FIG. 6B. On the right side of the interface is an edit button 126 for project properties 128 which will take the user back to the original project settings page 102. This allows the project manager 42 to go back in and make any necessary edits to those project settings. Just below the project properties is another heading, project settings 130 where two new project settings interfaces are stored: project contacts and point range assignments. The project manager 42 can also access shot codes and manufacturers here as well as back in the project properties edit. Lastly, there is a final deliverables 132 interface that will allow the project manager 42 or other users to indicate which final deliverables should be generated by the project management system 2.

Similarly, a project contacts interface (not shown) allows the project manager 42 to enter new contacts (e.g. contractors or other team members) or search through existing contacts to be utilized on a project. The project manager 42 can also delete contractors or other contacts from the list if they are not needed for the project being edited at that time. The project contacts interface includes the following fields: add new contacts; delete selected contacts; save changes; edit name of contact; edit user ID; designate crew chief; and edit contact information.

The project manager 42 will determine which numeric identification numbers are used for shot identification for the various crews to use to ensure there are no identification duplications using a point range assignments feature.

Similarly, the project manager 42 can define spreads. Spreads are a division of a pipeline project determined by the project manager 42. A user can add new or delete old spreads. These spreads can be filtered by name, classification, starting point, ending points, and by notes. A spread details interface provides information and shows shot assignments by the spread and phases of a pipeline project. Spread details also have the “add new” and “delete” options for the user to update details of a spread. Spread details can also be filtered by name, classification, start, end, and by notes. Crew Spreads continue to have the Add New and Delete options for the PM to update details of the Crew. Crews can be filtered by Name, Classification, Start and End.

The final deliverables are the finished requirements of a project, and may be automatically generated by the project management system 2. These may include: a final set of alignment sheets; the drawing files (e.g., .dwg computer aided drafting (CAD) files); a hard copy format, spread sheet, or import/export files for PODS or APDM; and/or scanned copies of survey books (e.g. in .pdf file format).

### IV. Digital Maps

Briefly discussed above and shown in FIGS. 8A and 8B is another major feature of the preferred embodiment of the present invention: the digital maps view interface 150 which can be utilized to view projects geospatially. There are many tools available in the digital maps view interface for viewing project data, including: Feature details linked to documents of a project; up to date visual progress of a project; and creating maps of a finished project. The tools associated with these tasks are accessible to the user via the GIS digital maps view toolbars, the general tools toolbar 152 and the analysis toolbar 154. The general tools toolbar includes the option to adjust map views, print maps and reports, and to identify and search for map features.

The map views interface 150 tool expands into an interface which includes initial extent and show legend tools. Initial extent produces the extent of the project seen in the digital maps viewing pane 156. The show legend tool allows the user to toggle the map legend 174 on or off from the digital maps viewing pane.

The printing and reports tool expands into an interface which includes the print map and reports tools. Print map allows the user to print the extent displayed in the digital maps viewing pane. The digital maps view can display the project extent or a section of the project. Reports will create a table view that can be exported to a PDF file or similar file format.

The identity and search tool expands into an interface which includes the point identity tool and the search for map features tool. The point identity tool will allow the user to identify different features on the map. The search for map features tool is a query building tool allowing the user to define searches by feature attributes.

Similarly, the analysis toolbar 154 includes several functions including: location information; measurement tools; “go to” location; and clear graphics tool.

Each location tool can be used to identify a specific feature in the project. Additionally there is a dropdown menu for the searching in tool. The searching in tool can be used to search by station ID, field data or survey status. The location information toolbar has five identify tools: (1) point identify; (2) freehand identify; (3) line identify; (4) polygon identify; and (5) rectangle identify. These identify tools function as their names imply: a selection can be made on the viewing pane 156 according to the tool chosen, and identification of details within the selection area are provided.

The measurement tools function similarly. The measurement tools allow the user to measure the distance, area, and perimeter of a selection within the viewing pane and allow the user to choose a unit of measurement (e.g. miles) from a separate dropdown menu.

The “go to” location tool allows user to choose a location to zoom to within the viewing window by entering X- and Y-coordinates.

The clear graphics tool allows the user to remove graphics from the viewing pane. This is convenient when performing searches, as the user may wish to clear a first search before performing a second.

The digital maps interface 150 includes a table of contents interface 158, which is located in proximity to the digital maps viewing pane 156 and includes a search function for its features. As shown in FIG. 8A, the search function is a query tool which the user has the ability to search through by tract, owner, or station. The table of contents also includes a legend drop-down menu allowing the user to place the legend in the table of contents 158, move the legend around within the viewing pane, hide, and remove the legend once added. Within the legend drop-down menu are options for the user to maneuver the legend around the viewing pane 156, change the legend format, or to hide the legend.

The legend allows the user to turn on and off layers within the map viewing pane 156. Slider controls 160 allow the user to adjust the transparency levels of various layers. The legend can be docked in different locations throughout the viewing pane, or it may be turned off completely.

### V. Project Info Management

FIG. 6A shows an example of the type of data management which may be available for a hypothetical project. The project info page 120 can be viewed after opening a project from the projects library (FIG. 7) as mentioned above.

The add data and documents 122 function allows data to be uploaded for a project, such as: Import mill reports; pipe tallies; point data; field notes; road bores; river crossings; and other relevant map and project data.

Data is reviewed by a data technician 62 in the office 6. The data is pulled into computer-aided drafting (CAD) software (e.g. AutoCad by Autodesk, Inc.) and checked for errors in the field survey. Errors are corrected. Such errors might be duplicate shot ID's, unintentional records or survey code values. Once all corrections are made and quality control performed, the data technician 62 will then approve the data file. Once the data file is approved the status of the file changes from “Raw” to “Office Reviewed”.

Data testing is the process the project management system 2 automatically goes through after data is uploaded through the add data and documents function 122. The test on the data includes: shot code validation; shot identification validation; and shot duplication identification and removal.

Pipe segments may be grouped into collections of segments to create features such as road bores, cross overs, river crossings, and other features. Feature groups can be accessed through add data and documents function 122 or the view data and documents function 124. The feature groups tool includes an “Add New” feature option. There are fields for names, type, station, elevation, station start, station stop, status, notes, date feature group was created, updated, and user.

Once data has been transferred through the import data and documents function 106, files can be selected for review and verification and then uploaded and processed in a three step operation. Step 1 requires data to be selected. Data is selected by file type, category, and/or crew member assigned to process. Files can also be selected using a separate browser window.

Step 2 is validating the data and linking the data with the features. This step occurs as where the data technician 62 checks for errors using tabular review within the management system alongside CAD software review when necessary. Errors being checked for include duplicate shot ID's, unintentional records or incorrect survey code values. Once all corrections are made and quality control performed by the data technician 62 then the data file is validated and ready for further processing.

Step 3 is processing the data. The user selects files that have been reviewed and validated and processes them by uploading selected files to the server 8.

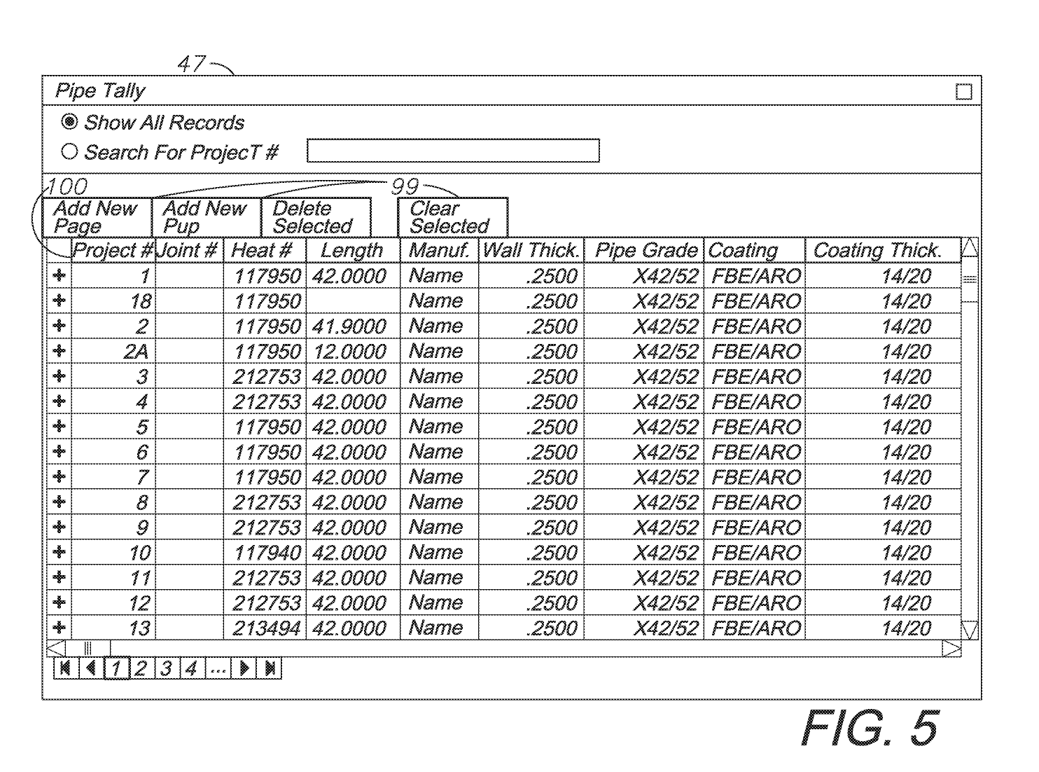

Refer to FIGS. 5 and 9A-9C which show a document access interface for accessing the documents underlying the data associated with the final deliverables. The pipe book 74 is a field book which allows a user to review the pipe tally 47. Data can be queried by record or by project ID 100. The pipe tally 47 includes data used in the project ID, joint numbers, heat numbers, length, manufacturer, wall thickness, pipe grade, pipe coating, and coating thickness. New pipes can be added or deleted along with pups using the reference tabs 99 located at the top of the pipe tally 47 chart.

A shot review feature allows the user to review the field data shots. Once a shot file is selected, the reviewer can set the review status of a shot. This information would likely pop up in a different window or as a menu within the interfaces shown in FIG. 5 or 9A-9C. Information included and editable may include labels for the shots including “raw,” “office reviewed,” or “published.”

Similarly, a field data shot review feature is where the as-built data shot data collected in the field is reviewed. The daily collected shot data includes the file name, date, crew name, and log file of each shot It also includes a file name list that identifies the status of a shot. The status of a shot can be raw, office approved, published, or duplicates.

Integrity tests can be run at any time; however, the ideal time for such a test is after importing and prior to publishing the as-built table. Integrity reports may be exported to .csv files (or other usable file-types) if the user desires to view them in the map viewer prior to publishing the data.

When a map for a project is rendered, all previously published points will appear. In the preferred embodiment of the present invention, points that have been published and maps into the geodatabase appear as triangles. Points that have been published and are waiting to be mapped appear as colored dots (circles). See FIG. 8B. The larger dots represent points that have been imported into the geo-database and are waiting for publishing. It should be noted that these symbols are merely one example of symbols that could be used to represent this data.

The user may wish to view the integrity report results on the map and bring-up the shot records in a grid. After the survey shots have been added to the system 2, the shots may be reviewed for logical errors (e.g. weld-to-weld connectivity and pipe-to-pipe connectivity) as well as spatial errors or the proper placement and sequencing of shots. The as-built survey shot data may be edited in the working data grid. As changes are made, those edits are reflected in the mapped data. When the technician 62 has approved the survey shots the status is changed to publish that data, it will appear in a separate output window 164 beneath the working window 162. After the shots have been reviewed and approved they are then committed to the database.

Throughout the project, status alerts may be sent to key project staff members as designated by the project manager 42. These messages could be sent via email, MMS, SMS, text message, or through the project management system 2 software itself. Details included with the status alert message may include copies of new data or document uploads or survey shot review status reports.

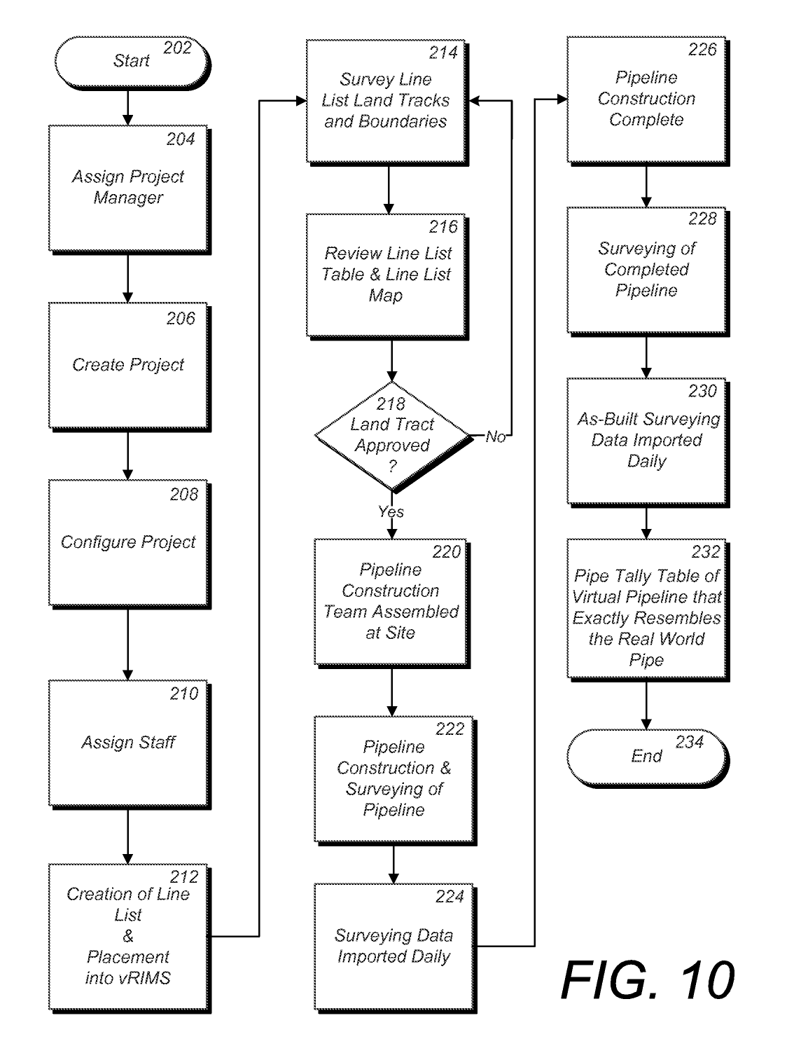

Summarizing, FIG. 10 goes through a basic step-by-step method of practicing the present invention. The process starts at 202 and a project manager (or multiple PMs) are assigned to the project at 204. The project manager creates a new project at 206. Alternatively, the project manager could elect to open an already created project at this point and start from there.

The project is configured at 208, as described in detail above. This includes all of the elements shown in FIG. 6A. Staff is assigned at 210, where different crews and staff are appointed for the various phases and assignments associated with the project. Again, see FIG. 6A.

The project manager and appropriate staff create the line list and placement and place those into the project management system at 212. The survey crew surveys the line list land tracks and boundaries at 214 and a review of the line list table and the line list map occurs at 216. This may be done by the data technicians in the office or by other entities on site. The line list, boundaries, and maps must then be approved at 218. If they are not approved, points are further surveyed or re-surveyed at 214 again by the survey crew. If those elements are approved at 218, then the pipeline construction teams are assembled at the site at 220.

Pipeline construction and surveying of the pipeline by the field crews occurs at 222. The surveying crews submit their surveying data such that it is imported into the project management system at 224 on a daily basis (or at a frequency determined by the project manager). This continues until pipeline construction (for each piece, weld, joint, etc.) is complete at 226 and surveying of the completed pipeline occurs at 228, verifying and being checked against all of the prior-recorded data.

The as-built surveying data as recorded and checked is imported into the project management system 2 at 230 daily (or at a frequency determined by the project manager) as each constructed piece of the project is recorded by the as-built survey team.

An as-built pipe tally of the virtual pipeline generated using the as-built survey data is generated at 232. This line list table resembles the real world pipe and can be used to generate an as-built map feature. The process ends at 234 with the final line list and deliverables generated by the project management system 2.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. An infrastructure deliverables generating system comprising:
a central server computer including a master database for storing recorded field data and processed office data;
a field computer configured to receive said field data including geospatial positioning system data points associated with construction of a piece of infrastructure;
said field computer configured to transmit said data to said central server and to an office computer located remotely from said field computer;
said office computer configured to process said field data and transform said field data into deliverable data; and
final deliverables generated by said central server based upon said field data and said office data, wherein said deliverables include at least an automatically generated map of said piece of infrastructure.

2. The system of claim 1 further comprising:
said map comprising a plurality of points, wherein said points refer to features of said infrastructure as built; and
said points indicating a status associated with each of said features.

3. The system of claim 1, further comprising:
said map comprising indication lines designating regions of said map, wherein said indication lines designate regions selected from the list comprising: property ownership boundaries; environmental areas; archeological sites; crossings; preliminary pipeline center-line; line list; control points; and section corners.

4. The system of claim 1, further comprising:
said final deliverables further including a table of infrastructure features; and
said table being automatically populated from said field data and said deliverable data by said central server computer.

5. The system of claim 4, wherein said table comprises a line list including data selected from the list comprising: property owners; tract identification numbers; status fields;
right-of-way status; environmental assessment status; and archaeological assessment status.

6. The system of claim 4, wherein said table comprises a pipe tally including features associated with an as-built pipeline, the features selected from the list comprising: project identification number; joint number; heat number; weld number; length; manufacturer; wall thickness; pipe grade; pipe coating; and coating thickness.

7. The system of claim 1, further comprising:
survey equipment including a global navigation satellite system (GNSS) antenna and receiver configured to provide accurate positioning coordinates;
said survey equipment automatically recording and storing said positioning coordinates;
said survey equipment automatically sending said positioning coordinates to said central server computer; and
wherein said positioning coordinates are used by said central server computer to generate said map.

8. An infrastructure deliverables generating system for a pipeline, the system comprising:
a central server computer including a master database for storing recorded field data and processed office data and a software platform configured for data input and viewing;
a field computer configured to receive said field data including geospatial positioning system data points associated with construction of a piece of infrastructure;
said field computer configured to transmit said data to said central server and to an office computer located remotely from said field computer;
said field data comprising preliminary data including a line list comprising property data, an initial land survey comprising property boundaries, and an environmental survey comprising features and boundaries;
said field data further comprising construction data including bore attributes, pipeline data, and connections data;
said field data further comprising as-built data including an as-built line list comprising property data, an as-built pipeline survey comprising pipeline attribute data, and a pipe tally comprising inventory and accounting data;
said office computer configured to process said field data and transform said field data into deliverable data;
final deliverables generated by said central server based upon said field data and said office data, wherein said deliverables include an automatically generated map of said piece of infrastructure and a corresponding table of infrastructure features;
said map comprising a plurality of points corresponding with an as-built pipeline; and
said table comprising said deliverable data.

9. A computer-implemented method for managing an infrastructure project and producing final deliverables, comprising executing on a processor the steps of:
receiving field data corresponding with a piece of infrastructure as constructed at a work site in a central server computer having a master database and a software platform configured for data input, data reviewing, and generating final deliverables;
storing said field data in said master database;
accessing said field data with an office computer having data storage and software configured for reviewing said field data;
generating deliverable data with said office computer from said field data and storing said deliverable data on said master database; and
generating a final deliverable with said central server computer, said final deliverable comprising an automatically generated map of said piece of infrastructure and a corresponding table of infrastructure features, said map comprising a plurality of points corresponding with said infrastructure as built.

10. The method of claim 9, further comprising the steps:
generating and storing coordinate data of said infrastructure with survey equipment comprising a GNSS antenna and a GNSS receiver;
storing said coordinate data on said master database as part of said field data; and
generating said map with said coordinate data using said central server computer.

11. The method of claim 9, wherein said map comprises indication lines designating regions of said map, wherein said indication lines designate regions selected from the list comprising: property ownership boundaries; environmental areas; archeological sites; crossings; preliminary pipeline center-line; line list; control points; and section corners.

12. The method of claim 9, wherein:
said final deliverables further including a table of infrastructure features; and
said table being automatically populated from said field data and said deliverable data by said central server computer.

13. The method of claim 12, wherein said table comprises a line list including data selected from the list comprising: property owners; tract identification numbers; status fields;
right-of-way status; environmental assessment status; and archaeological assessment status.

14. The method of claim 12, wherein said table comprises a pipe tally including features associated with an as-built pipeline, the features selected from the list comprising: project identification number; joint number; heat number; weld number; length; manufacturer; wall thickness; pipe grade; pipe coating; and coating thickness.
